(19) United States
(12) Patent Application Publication
(10) Pub. No.: US 2022/0172223 A1
(43) Pub. Date: Jun. 2, 2022

(54) Greenhouse Gas Neutral (GHGn) & Greenhouse Gas Plus (GHG+) Built Environment(s)

(71) Applicant: Andrey F. Burrell, Au Zh (CH)

(72) Inventor: Andrey F. Burrell, Au Zh (CH)

(21) Appl. No.: 17/436,592

(22) PCT Filed: Jan. 24, 2019
(86) PCT No.: PCT/IB2019/000027

§ 371 Date: Sep. 17, 2021

(51) Int. Cl. G06Q 30/00

(52) U.S. Cl. CPC G06Q 30/018

(57) ABSTRACT

Greenhouse Gas Neutral (GHGn) and Greenhouse Gas Plus (GHG+) Built Environment(s) is a solution that quantitatively accounts for an mitigates carbon dioxide equivalency (CO2e) emissions (carbon dioxide, methane, nitrous oxide, sulfur hexafluoride, hydrofluorocarbons, perfluorocarbons, and nitrogen trifluoride) from the complete building process. This includes the carbon dioxide equivalency footprinting from the structure's products and services that are aggregated through the physical structure's total area. The invention's carbon neutral process forms the GHGn or GHG+ securitized product that is authenticated with the real estate asset's title. Thereby it perpetually conveys the structure's performance of increased asset value and carbon neutrality in the real estate industry.

The four carbon neutral building standards are defined by the level of emissions measurement rigor and grouped through the impact quantification areas of planning, construction, and occupancy, each of which either produce or mitigate greenhouse gas emissions. The four universal standards according to Greenhouse Gas Neutral (GHGn) and Greenhouse Gas Plus (GHG+) Built Environment(s) are as follows: Green, Emerald, Sage, & Pine.

The built environment securitized product is either Greenhouse Gas Neutral (GHGn) or Greenhouse Gas Plus (GHG+).

### 1.) TECHNICAL FIELD

Greenhouse Gas Neutral (GHGn) and Greenhouse Gas Plus (GHG+) Built Environment(s), specifically results in carbon neutral buildings, residences, and urbanism. The invention factually addresses greenhouse gases also referred to as carbon emission(s) from the entire real estate process comprised of land-use, planning, construction, and occupancy that form the invention's basis of novelty through total carbon dioxide equivalent measurements from all building processes that include professional services, building products, and the subsequent occupancy or use of such structures. The invention constitutes and in part solves climate change through total building envelope emissions' measurement formed by its carbon neutral modus.

### 2.) DISCLOSURE OF INVENTION

Greenhouse Gas Neutral (GHGn) and Greenhouse Gas Plus (GHG+) Built Environment(s) is a solution that quantitatively identifies, accounts for, and partially solves carbon dioxide equivalency concentration levels in the atmosphere (global warming). GHG Neutral (GHGn) is one hundred percent mitigated carbon dioxide, methane, nitrous oxide, nitrogen trifluoride, sulfur hexafluoride, hydrofluorocarbons, and perfluorocarbons. GHG Plus (GHG+) equates to a carbon dioxide equivalency negative surplus that supersedes the total structure's greenhouse gas balance from the defined areas of measure throughout the complete building life cycle. In both GHG Neutral and GHG Plus cases, the completed building life cycle includes emissions produced from all building processes and emissions that are mitigated. All services and products are accounted for, measured (footprinted), and authorized with the real estate asset's title. The GHGn or GHG+ Built Environment, expressed by total emissions measured and total emissions mitigated, is the result of the carbon neutral process that comprises the GHGn or GHG+ securitized product that is authorized with the real estate asset title.

### 3.) BRIEF DESCRIPTION OF DRAWINGS

The information in the drawings, figures, and figurative descriptions contain the carbon neutral process that comprise Greenhouse Gas Neutral (GHGn) and Greenhouse Gas Plus (GHG+) Built Environment(s). The Impact Legend characterizes each of the emissions sources that either produce or reduce greenhouse gas emissions. The Impact Legend has ten specific emission indicators that are symbol coded by ten different shape proportions. Each of the ten emission indicators includes either a plus or minus that denotes either a production or a reduction of greenhouse gases.

FIG. 1: Greenhouse Gas Neutral (GHGn) and Greenhouse Gas Plus (GHG+) Built Environment(s)

Figure One constitutes the Greenhouse Gas Neutral (GHGn) or Greenhouse Gas Plus (GHGn+) Built Environment. In chronological order, Figure Two, Three, Four, & Five form the Greenhouse Gas Neutral (GHGn) or Greenhouse Gas Plus (GHG+) Built Environment. The figures entail thirteen processes that result in carbon neutral structures. These modi comprised in Greenhouse Gas Neutral (GHGn) and Greenhouse Gas Plus (GHG+) Built Environment(s) are Process One ([P1] Landuse Sequestration Footprint), Process Two ([P2] Service Transit), Process Three ([P3] Stationary Equipment), Process Four ([P4] Material Footprint), Process Five ([P5] Equipment and Tools), Process Six ([P6] Material Shipping), Process Seven ([P7] People Transit), Process Eight ([P8] Recycling and Waste), Process Nine ([P9] Power and Energy), Process Ten ([P10] Product Specification), Process Eleven ([P11] Standard), Process Twelve ([P12] Operational Emissions Audit), and Process Thirteen ([P13] GHGn or GHG+).

FIG. 2: Impact Quantification

Figure Two indicates each impact quantification area from planning, construction, and occupancy that either produce or mitigate greenhouse gas emissions comprised in the GHGn and GHGn+ Built Environments' carbon neutral building process. Figure two includes Processes One through Ten.

FIG. 3: Carbon Neutral Standard

Figure Three is the standard that is awarded as part of GHGn and GHG+ Built Environments' carbon neutral building process. The carbon neutral standard is formed by the level of emissions measurement rigor. The standards are grouped to the complete building process that either produce or reduce emissions. The standard's requirements precisely align to each impact area associated with the real estate's fulfillment. Figure three includes Processes Eleven through Twelve.

FIG. 4: Greenhouse Gas Neutral (GHGn) or Greenhouse Gas Plus (GHG+) Built Environment

Figure Four defines whether the completed structure is greenhouse gas neutral or achieves a greenhouse gas surplus, expressed by total emissions measured and total emissions mitigated. This is the result of the carbon neutral process that comprises the GHGn or GHG+ securitized product that is authorized with the real estate asset's title.

FIG. 5:

Figure Five is the GHGn or GHG+ Built Environment securitized product. FIG. 6:

Figure Six are the Greenhouse Gas Neutral (GHGn) and Greenhouse Gas Plus (GHG+) Built Environment(s) figurative descriptions.

### 4.) BEST MODE FOR CARRYING OUT THE INVENTION

Greenhouse Gas Neutral (GHGn) & Greenhouse Gas Plus (GHG+) Built Environment(s) can be implemented in every property type regardless of scope, size, scale, or physical location. Due to the carbon neutral process comprised from the total amount of metric tons of greenhouse gases measured and total amount of metric tons of greenhouse gases mitigated being absolutely attached to the real estate asset, the best mode for executing the invention is the securitized product (FIG. 5).

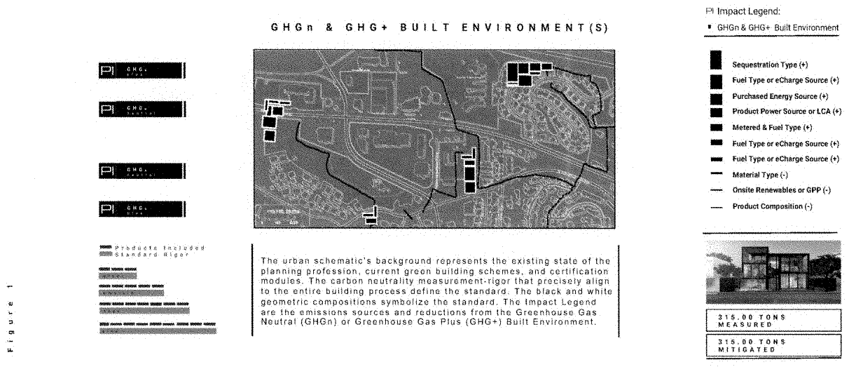

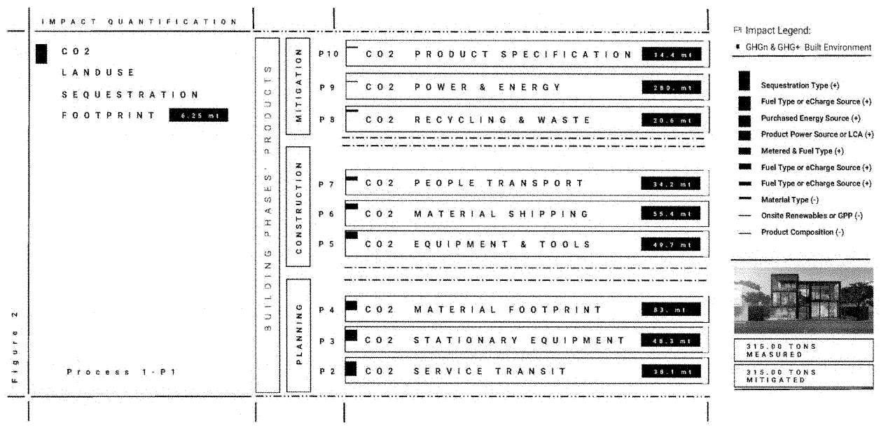

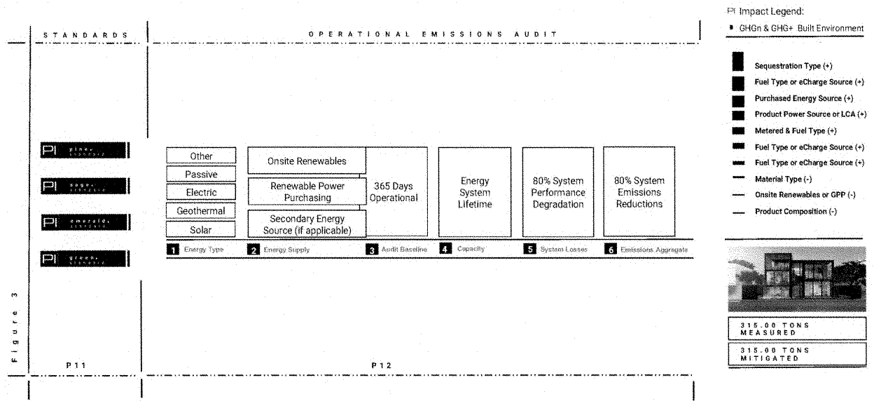

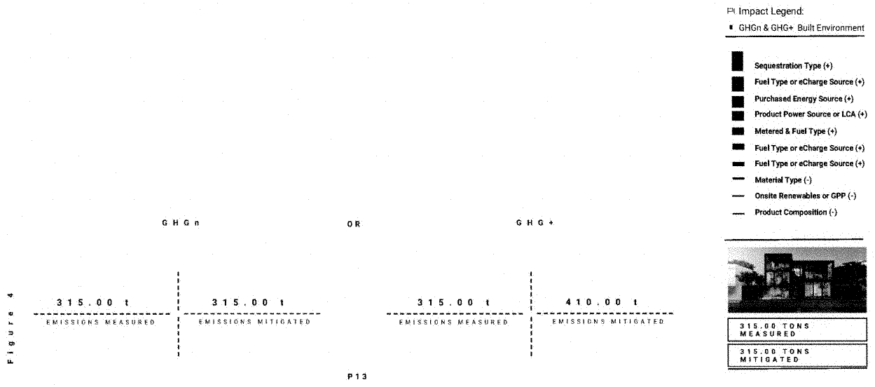

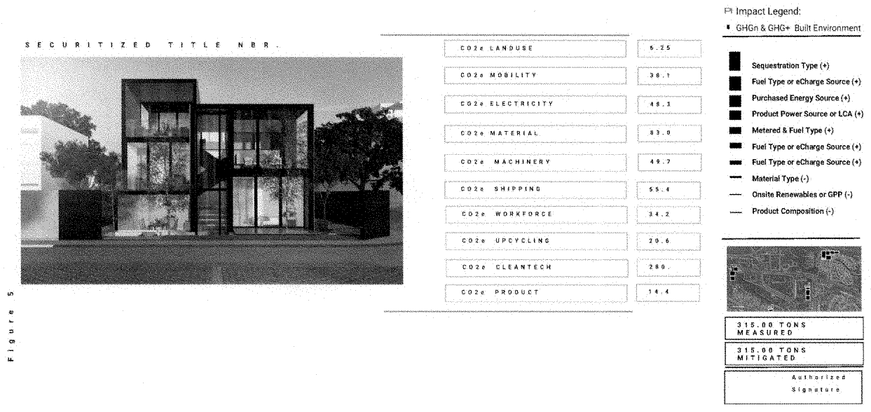

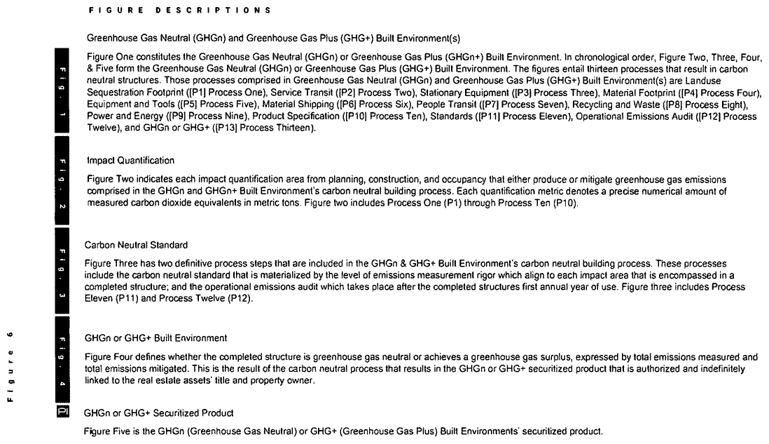

1. The invention claimed is Greenhouse Gas Neutral (GHGn) & Greenhouse Gas Plus (GHG+) Built Environment(s) (FIG. 1), as expressed by metric tons of total emissions measured and total emissions mitigated from the carbon neutrality comprised in its process (FIG. 2-4).

2. The GHGn & GHG+ Built Environment(s) (FIG. 2) modus of claim 1 further comprising the Landuse Sequestration Footprint (Process One) accumulates the total metric tons of greenhouse gases that are not sequestered from grasslands, forests, and soil are quantified in units of area (acres, hectare acres) and appropriated to the real estate asset based upon its total area (square feet, square meters).

3. A GHGn & GHG+ Built Environment(s) (FIG. 2) modus as recited in the method of claim 1 further constituting Service Transit (Process Two) measures the carbon dioxide equivalent emissions from all planning service transit, totaling the annual metric tons of greenhouse gases from mobile combustion which are quantified and appropriated to the physical structure in units of area (square feet, square meters).

4. The GHGn & GHG+ Built Environment(s) (FIG. 2) apparatus of claim 1 further forming Stationary Equipment (Process Three) accounts for the carbon dioxide equivalent emissions derived from all stationary equipment that is used by professional service providers throughout the building process, wherein the total annual metric tons of greenhouse gases from electricity are allocated based upon aggregated planned units of area, then appropriated to the physical structure in units of total area (square feet, square meters).

5. A GHGn & GHG+ Built Environment(s) (FIG. 2) as recited in the method of claim 1 further including Material Footprinting (Process Four) measures the carbon dioxide equivalent emissions, wherein the energy source used to manufacture and assemble is determined, thus resulting in the total annual amount of metric tons emitted to produce each building product or group of building products; wherein the GHGn & GHG+ Built Environment(s) totals the annual metric tons of emissions derived from the product(s) specified, then allocated to the physical structure based upon the amount of product specified in units of area (square feet, square meters) or quantity (numerical).

6. The GHGn & GHG+ Built Environment(s) (FIG. 2) modus of claim 1 further comprising Equipment & Tools (Process Five) accounts for the carbon dioxide equivalent emissions from all heavy machinery that is used onsite to construct the structure, as well as all electrical tools used by construction professionals to build the structure; wherein the total annual metric tons of greenhouse gases from the fuel that powers the heavy machinery are quantified and appropriated to the structure in units of area (square feet, square meters) and the total annual metric tons of greenhouse gases from the electricity consumed to assemble the structure's infrastructure, exterior, and interior are metered and directly summed to the physical structure.

7. A GHGn & GHG+ Built Environment(s) (FIG. 2) as recited in the apparatus of claim 1 further including Material Shipping (Process Six) measures the carbon dioxide equivalent emissions from all building material deliveries, wherein the total annual metric tons of greenhouse gases from mobile combustion are quantified and directly summed to the physical structure by each shipment of goods' origin to their destination point in unit of length (miles, kilometers); or the total annual metric tons of greenhouse gases from mobile combustion are quantified and appropriated to the physical structure in units of volume (cubic feet, cubic meters) based upon each product shipment's gross volume.

8. The GHGn & GHG+ Built Environment(s) (FIG. 2) modus of claim 1 further forming People Transportation (Process Seven) accounts for the carbon dioxide equivalent emissions from all construction fleets, wherein the total annual metric tons of greenhouse gases from mobility's fuel combustion are quantified and appropriated to the physical structure in units of area (square feet, square meters).

9. The GHGn & GHG+ Built Environment(s) (FIG. 2) apparatus of claim 1 further comprising Recycling and Waste (Process Eight) quantifies the carbon dioxide equivalent emissions reduced by the reprocessing of building materials that are placed back into the manufacturing lifecycle, wherein the net weight in units of mass (short tons, tons) of each recycled construction material are totaled, and directly summed to the physical structure in units of mass (metric tons).

10. The GHGn & GHG+ Built Environment(s) (FIG. 2) modus of claim 1 further entailing Power and Energy (Process Nine) are the emissions mitigations from onsite renewable energy or directly verified green power purchasing that are amortized according to the emissions reductions clean power source after the structure's first year of operation, wherein the total annual mitigated metric tons of greenhouse gas emissions are measured in units of mass (pounds, short tons, kilograms, tons), amortized by the renewable energy system's percentage performance losses and appropriated to the physical structure's total emissions balance.

11. A GHGn & GHG+ Built Environment(s) (FIG. 2) as recited in the modus of claim 1 further forming Product Specification (Process 10) contains the quantification of emission reductions from building material compositions, wherein each emissions-reducing product is measured in units of area (square feet, square meters), allocated to the physical structure in units of mass (pounds, short tons, kilograms, tons) and accredited to the physical structure's total emissions balance.

12. The GHGn & GHG+ Built Environment(s) (FIG. 3) modus of claim 1 further including Standards (Process Eleven) is derived from the level of total emissions measurement rigor from each emissions-producing activity throughout the complete building process, wherein the externally audited, standardized marketing mechanism is grouped according to the real estate lifecycle through universal performance ratings that convey the physical structure's carbon neutrality.

13. The GHGn & GHG+ Built Environment(s) (FIG. 3) modus of claim 1 further comprising an Operational Emissions Audit (Process 12) wherein the first annual year of total electricity generated or electricity supplied is measured in units of energy (kWh, Mwh, Joule), summed by the energy system's degradation, and aggregated to the structure's total emissions balance in units of mass (pound, short ton, kilogram, ton).

14. A GHGn & GHG+ Built Environment(s) (FIG. 4) as recited in claim 1 further forming the GHGn or GHG+ Built Environment (Process 13), wherein the completed carbon neutral structure is expressed as total metric tons of emissions measured and total metric tons of emissions mitigated.
